(19) United States
(12) Patent Application Publication
(10) Pub. No.: US 2010/0125803 A1
(43) Pub. Date: May 20, 2010

(54) Online System for Communications Between Service Providers and Consumers

(76) Inventor: Tyler Johnson, Fort Mill, SC (US)

Correspondence Address: SUMMA, ADDITON & ASHE, P.A., 11610 NORTH COMMUNITY HOUSE ROAD, SUITE 200, CHARLOTTE, NC, 28277, US

(21) Appl. No.: 12/620,133

(22) Filed: Nov. 17, 2009

Related U.S. Application Data
(60) Provisional application No. 61/115,494, filed on Nov. 17, 2008.
(60) Provisional application No. 61/144,889, filed on Jan. 15, 2009.

(51) Int. Cl. G06F 17/30; G06F 3/01

(52) U.S. Cl. 715/760; 707/769

(57) ABSTRACT

An online communications network connects consumers with service providers from an unlimited number of different business sectors. The service providers include event organizers. The network allows consumers and event participants to maintain a profile of biographical data on the system. The single profile is available to either purchase services or register for events in a single electronic marketplace. A computerized method of arranging information about the service providers includes assigning codes, such as SIC and NAICS codes, to categories of services and arranging individual service providers, including event organizers, within their respectively assigned categories. Consumers and service providers communicate over the website to contract for work, rate each other's performance of the contract, provide referrals for other business. In the events section, event participants and event organizers share registration information. The system includes a social networking component for better relationships between service providers and their customers.

### CROSS REFERENCE TO RELATED APPLICATIONS

This application claims priority to related U.S. Provisional Patent Application Ser. No. 61/115,494 filed on Nov. 17, 2008. This application also claims priority to related U.S. Provisional Patent Application Serial No. 61/144,889 filed on Jan. 15, 2009. Both provisional applications are incorporated by reference as if fully set forth herein.

### FIELD OF THE INVENTION

The invention relates to online communications and advertising systems for (i) connecting consumers to service providers and vice versa; (ii) connecting event participants to event organizers; (iii) tracking historical records of transactions between consumers and service providers; (iv) providing reporting functionality for service contracts; and (v) allowing for communications in a social network that provide a mechanism for groups of people to correspond in regard to jobs completed by service providers on behalf of consumers.

### BACKGROUND

The invention includes a new kind of online social and business network based upon the need for matching consumers with service providers within the framework of electronic commerce. The service providers may include individuals and other entities who are planning events for which event participants need to register.

Although e-commerce already encompasses certain limited methods of connecting consumers to very specific service providers, no online system available today allows for different consumers with diverse needs to search in a common place for service providers from all sectors of the economy. This need is especially prevalent when the service being provided is event organization.

It is well known that numerous websites and communications networks currently exist by which individuals exchange information over the Internet. All web-based social networks (e.g., MySpace™ and Facebook®) allow groups of individuals with common interests to share access to web pages created for personal communications. Individuals all over the world post writings, photos, musical compositions and other digital works on these web pages. Typically, full access requires certain permissions from the individual controlling the web page.

Other kinds of websites involve less personal exchanges of information, particularly in the form of advertisements for goods and services. For example, craigslist.com is a commonly used site for advertising goods and services for sale. Craigslist® is especially useful for buying and selling previously owned consumer products with remaining useful life, but it also allows various service providers to advertise their services in an online environment. Craigslist®, however, has limited organization other than geographical locations for searchers to use in looking for particular goods or services. Otherwise, the entries, mostly advertisements, are in the order of the time that they were written and posted on the site. Also, Craigslist® has limited ability for providing a user any feedback concerning the quality of sellers or buyers on the system.

Even more well-known than Craigslist® is eBay®, which has become an internet phenomenon for selling goods. Users have accounts on eBay® for posting items for sale, including descriptions and/or photographs of the item. As is well known in the art of electronic commerce, eBay® conducts public auctions at all price levels until a bidder wins during an allotted time period. eBay users can rate the sellers and buyers to show whether that individual is sufficiently trustworthy to merit a business transaction. eBay® groups items for sale in descriptive categories that are organized largely on an alphabetical basis. Users consummate transactions by known combinations of email, electronic commerce payment systems, and standard shipping methods. Due to the nature of the eBay® auction system, very few service providers place services for bid on the system, although eBay® does provide limited functionality for selling services in an online environment.

One avenue for retrieving online information regarding services is the website “Workstir.com.” Workstir allows people to post online requests to purchase services in a particular geographical area. Service providers peruse the postings and send return offers to the consumer's account box on the Workstir system. The offers from the service providers typically provide links to the workers' profiles along with ratings that the service provider has received from prior jobs. A service provider may directly provide the link to that service provider's profile on Workstir, but Workstir also has the ability to connect and share information from a service provider's Facebook® account. The Facebook® connection is also available to provide information about the consumer seeking services. The Facebook® connection makes certain search processes more efficient, such as ensuring that the a consumer's work request is sent to service contractors in the appropriate geographical area. The Facebook® connection also includes a mechanism for updating Facebook® accounts with information about the Workstir project and the quality of the job after completion.

A different resource for assisting consumers in evaluating service providers is set forth in Angie's List®. Angie's List® is an online compilation of reviews regarding service companies and allows consumers to see those reviews for a fee. Angie's List® is similar to an annotated set of yellow pages with reviews for each alphabetical entry.

In the business to business sector, ARIBA's e-sourcing program allows a business to evaluate sources for goods and services. ARIBA® provides a web-based software for developing commercial documents, such as Requests for Information, Requests for Quotes, Requests for Proposals, or even an online auctioning system. ARIBA® offers a business-to-business model so that corporate entities can quickly define categories of services needed, contact service providers, and execute service source strategies. ARIBA's value added services include invoicing and payment systems, source evaluation, and overall procurement management.

The website for Wesabe is a further indication of how electronic commerce has developed into a broad based tool useful for purposes broader than simply purchasing goods. Wesabe combines a financial planning software with an online community for comments and tips. First, Wesabe allows individuals to upload current credit and cash spending records into one location. Wesabe then categorizes how that individual is spending money. This allows the consumer to see spending and earning summaries for better planning and for taking advantage of better spending practices. Wesabe is also an online community for sharing tips on how to save, where to shop, and for ranking both vendors and service suppliers for goods and services that show up in a consumer's spending records. The goal is to provide assistance in planning purchases and developing better spending habits.

In terms of previous patent publications for well-organized electronic commerce systems, U.S. Pat. No. 7,430,528 (Perkowski 2008) discloses an online system of providing consumers with product information over the Internet. The Perkowski system is organized by a system of codes that identify the products. According to the patent, virtually any kind of product can be registered within the system by symbolically linking or relating its pre-assigned Universal Product Number (or at least the Manufacturer Identification Number) to the URL associated with that product on the world wide web. By entering the UPN into the system, the consumer is taken directly to consumer product information for that device or good. The Perkowski '528 patent is relevant in its organizational structure—assigning codes to products to allow ease of information retrieval.

In regard to the services sector, U.S. patent application Ser. No. 11/154,937, published as Publication No. 20050288958 (Eraker 2005), discloses a web site serving as an online marketplace for real estate and related services. One embodiment of the marketplace provides a listing of member agents available for selection. Consumers may search this section to view agents and sort by categories such as experience, ratings, areas served, specialization, and other criteria showing experience and success in the field. The Eraker system also allows for consumers to post profiles describing themselves and their preferences in purchasing real estate. Overall, consumers and agents have profiles available on the system for searching and matching business opportunities in a real estate context. The Eraker system is also open to vendors in the real estate sector who provide services other than real estate marketing (e.g., construction companies, estimators, mortgage brokers, loan consultants, interior decorators, and the like). These third party vendors also maintain a profile on the system and advertise their work as well. The online system further provides forum opportunities for consumers, agents, and vendors to share experiences, information, and historical records of certain transactions.

In terms of matching a service provider in a single field with consumers searching for that one service, an example website is located at www.servicemagic.com. ServiceMagic maintains a database of construction contractors that the public can access by posting a need and certain criteria on the website. The website matches the consumer's request with qualified contractors on the system and connects the two. ServiceMagic, however, is limited to home services and provides no forum for the public to express quality ratings.

Even in light of the above works, the service sector is under-served by current electronic systems providing consumers with online access to service provider information. A need continues to exist for online systems that organize information regarding services available to consumers. The system should also assist in gathering feedback regarding service providers and consumers in completed transactions, record-keeping functions, and overall contract assistance in bringing service providers and consumers together in positively fulfilled transactions. This need is particularly acute in terms of systems that allow consumers to search within multiple service sectors in one location without being limited to specific industries.

### SUMMARY OF THE INVENTION

In a first embodiment, the system includes a computer program product for establishing an online advertising and communication system used by service providers and consumers. The computer program product is implemented on hardware including a computer readable storage medium with computer commands thereon for connecting a plurality of computers on the World-Wide Web. The programmed commands form a communications module executable by a computer processor to allow communications between service providers and their consumers. A search module within the computer program allows consumers to search for services by browsing categories of services with assigned codes, including but not limited to SIC codes, NAICS codes, or Internal Revenue Service Business Activity codes.

The invention also encompasses a computerized system of connecting service providers and consumers via an online communications network. The system may be implemented on a web server operable by connecting to the infrastructure of the Internet for coordinating the communications network over the World Wide Web. A plurality of client subsystems operate at points of presence on the World Wide Web, and each subsystem may be electronically connected to the web server and to each other. The client subsystems operate via at least one of each of (i) a consumer interface, (ii) a service provider interface, and (iii) an administrator interface. The interfaces include computer controlling commands executable on client and server processors to allow the exchange of data between any two of said interfaces. A coding interface allows an administrator to categorize the services so that consumers can quickly find the kind of service needed. The coding interface facilitates the assignment of a code to the services for optimal organization. This embodiment incorporates a service provider catalog on the web server and the catalog is organized by assigned codes. A search module on the web server allows for locating service providers in the catalog. The codes assigned to the service types include, but are not limited to, SIC codes, NAICS codes, or even IRS Business Activity Codes.

One objective of the hardware and system described herein is to accommodate communications between consumers and service providers in an online environment. These communications are encouraged by giving consumers access to consistent and objective data sets regarding the service providers for one to one comparison.

A different embodiment provides for using the service provider platform described above in the context of event planning. For an event to have individuals involved, an event organizer must be able to communicate with event participants and potential participants. In a computerized system for establishing online event management, a computer readable storage medium includes commands stored thereon for connecting a plurality of computers on the World Wide Web. The commands facilitate a communications module executable by a computer processor to allow communications between the event organizers and the event participants. The system incorporates an events manager including a profile manager for entering and storing identifying information regarding users of the computerized system (i.e., each user has a personal profile on the system). The users include event organizers and event participants. A search module includes computer storage for organizing events according to event organizer categories. A registration module extracts profile information from the profile manager and uses the profile information in completing a registration for at least one event. The event management system allows for the same profile information to be available for registering for multiple events from multiple event organizers listed in the search module.

Another embodiment of the system allows users to search for services (both business and personal), and from the same service sector platform, search for events that are useful to register. This combination of a services platform combined with an events management platform allows “one stop shopping” for individuals and companies to meet diverse needs without searching more than one location on the internet or otherwise. The system incorporates the concept that each service provider and every event organizer must present consistent kinds of information in their respective profiles and in their more substantive showrooms on the system. This consistency gives every user more opportunities to compare like information among entities on the system.

These and other objects of the invention are set forth in the Detailed Description below.

### BRIEF DESCRIPTION OF THE DRAWINGS

FIG. 1 is a flow diagram of the overall computerized system described herein.

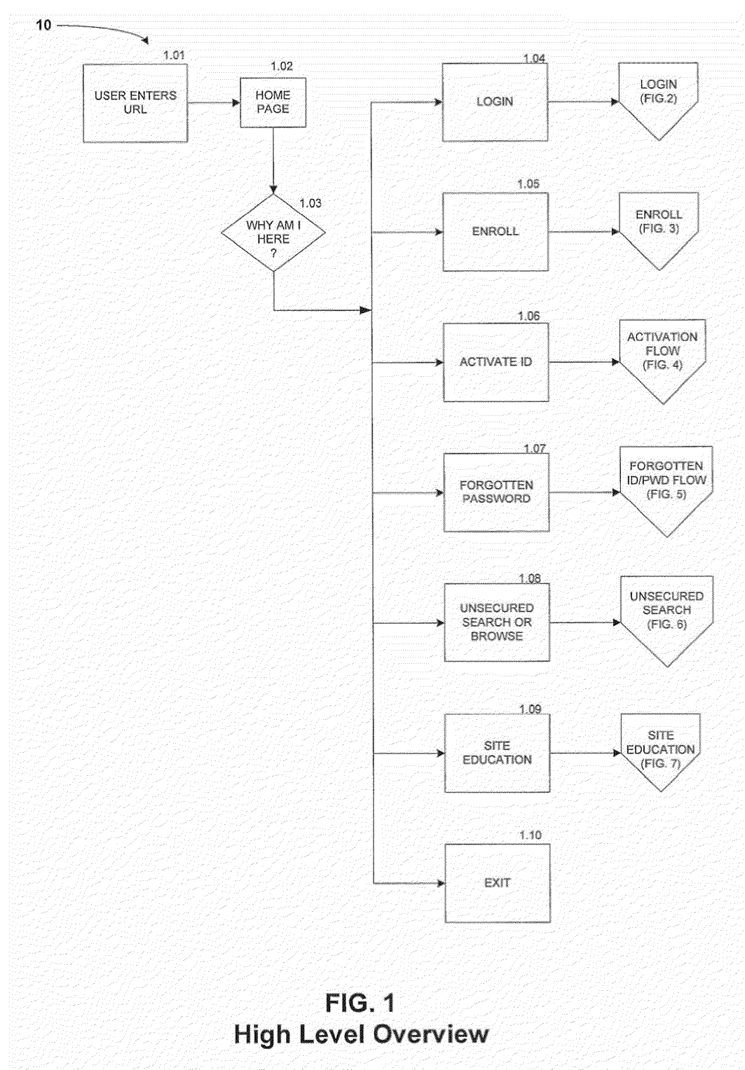

FIG. 2 is a flow diagram of the log-in procedure for users to gain access to the system for secured communications.

FIG. 3 is a flow diagram showing the enrollment procedure for becoming an authenticated user.

FIG. 4 is a flow diagram showing the steps necessary for user to activate his account on the system.

FIG. 5 is a flow diagram showing the steps for a user to change a password to allow secured communications on the system.

FIG. 6 is a flow diagram showing the process for enabling an unsecured search and browse feature on the system.

FIG. 7 is a flow diagram showing the options available to show a user the features of the system.

FIG. 8 is a flow diagram for a consumer to utilize the service provider search tools on the system.

FIG. 9 is a flow diagram for a consumer and a service provider to communicate via the system described herein.

FIG. 10 is a flow diagram for service providers, including event organizers, to execute transactions on the system described herein.

FIG. 11 is a flow diagram for a consumer who is a potential participant in an event organized and available via the system described herein.

FIG. 12 is a flow diagram showing examples of kinds of communications between an event participant and an event organizer pursuant to this system.

FIG. 13 is a flow diagram for an event organizer who seeks to register event participants in an event organized and available via the system disclosed herein.

FIG. 14 is a schematic depiction of user roles and privileges in the system of this invention.

### DETAILED DESCRIPTION

The online system of this invention allows independent service providers and consumers to access a centralized website that encourages successful business relationships between the parties. Generally, the consumer can quickly search the website for service providers of interest. Likewise, the service providers can manage the advertising content that they provide on the system. The online search tool helps consumers and service providers connect and enter into contracts for the provision of services.

One useful feature of this new web based service search tool is that the website is not limited to any particular service sector. All kinds of services may be managed from the website, allowing consumers with numerous and completely diverse needs to access the same centralized web location to find service providers for particular projects. In other words, the website is not limited to any particular service sector, but it is available to connect service providers of all business types with consumers of interest.

In one embodiment, the system is useful for event management. For purposes herein, and without limiting the invention in any way, an event includes any activity publicized for the purpose of attracting interest and having individuals, including business entities, participate. An individual or other entity planning and managing any aspect of an event may be referred to herein as an event organizer. An individual, business, or other entity who receives information regarding the event may be referred to as an event participant. An event participant may include potential participants who merely inquire or receive initial information about an event, whether or not the potential participant registers for the event. An event, therefore, may include any activity for which an event organizer would like to be in communication with event participants as well as with potential participants. In this sense, and again without limiting the invention, an event organizer distributes information about an event and provides more details about the event via the system described below. For this embodiment, the system encompasses event organizers as one kind of service provider on the system (i.e., an event may be a kind of service and an event participant a kind of consumer).

In one embodiment, the system and the information therein is predominantly organized according to individual service sectors. Accordingly, the system includes a coding interface by which an administrator uses a data entry device to assign customized codes for each service provider. The service providers can then be grouped together to allow quick access for users with similar needs.

This setup allows consumers and service providers quick access to highly relevant information that is useful in any given case. The system assigns a unique code via the coding interface to each kind of service available for searching on the system. This code may be the historical SIC code for each service sector identified on the system. More recently established coding schemes include NAICS codes that also arrange service industries according to standardized categories. The IRS Business Activity Codes are also available. In any case, the user will be able to access a centralized database with each service sector readily identifiable according to an appropriate code. The system incorporates both alphabetical and service code-oriented keys to ensure easy navigation to the right section of the information on the system. A word search function allows a user to quickly determine the category, and therefore the assigned code, for any service type. In some respects, the service provider sections are organized in an on-line service provider catalog for the user to browse, search, and retrieve information.

The system may include a computer program product for establishing an online advertising and communication system used by service providers and consumers. The system provides a centralized point on a network, such as the World Wide Web, where service providers of all types, price ranges, and business sectors unite for convenient access by consumers who are equally diverse in their needs. The computer program product of this invention includes typical physical components necessary to implement the overall system on the Internet. These physical components include a computer readable storage medium having commands stored thereon for connecting a plurality of computers on the World-Wide Web. The commands are implemented in commonly used computer languages and protocols for establishing network communications. Accordingly, a communications module within the computer program product is executable by a computer processor to allow communications between the service providers and the consumers.

The computer program product includes a set of computer commands that implements a search module on the system. The search module organizes service provider information according to assigned codes, as discussed above. In fact, one hallmark of the system of this invention is that the information therein is organized at the highest level according to service industry type. One convenient way to establish service industry types is to follow standards that are already in place as set forth in the previously established standards for NAICS codes, SIC codes, and IRS Business Activity codes. Any one of these codification schemes accomplishes the goal of providing a consistent and systematic approach to organizing information on the system so that users can quickly access information that is pertinent to any given project.

Upon accessing the system and directing the website to the appropriate service sector categorized by codes, a user, who may be either a service provider or a consumer looking to hire a service provider, may access profiles established on the system. Without limiting the invention in any way, a profile is a data set that includes certain objective information about a system user (either a consumer or a service provider). The profile also shows how individuals have scored in performance ratings that the system tracks for both consumers and service providers.

In one embodiment, the profiles available on the system include standardized data fields that must be completed by every individual participating in the online system. By requiring particular basic data, users are able to compare and gain a better sense of value in conducting business with a particular service provider or a given consumer. This is particularly important from the perspective of the consumer. In websites and directories of prior systems (whether online or not), the consumer has been able to access only the information that the service provider chose to make available. Different service providers provide different information, making it impossible for consumers to evaluate fairly on the basis of known standards.

According to the system disclosed here, the profiles may be required to include certain objective information, making comparisons more accurate. Typical standardized data fields for service providers include but are not limited to name, address, years in business, geographical areas served, identified areas of expertise, professional accreditations, number of customers served, and the averaged quality ratings given by system users for this service provider. Typical standardized data fields for consumers include a system identifier (instead of a name), city and state of residence, number of contracts completed on the system, and again an averaged quality rating given by service providers who worked with this consumer previously.

The standardized data sets for service providers assist consumers in being able to compare service providers on consistent factors. This is an improvement over individual websites created by different service providers because the independent websites likely include different combinations of information. The consumer benefits from being able to compare like kinds of data.

Individuals using the service provider system of this invention may search the system by either the codified service provider list or by a word search. By entering basic non-confidential information, a person browsing the Internet can access the public search tools on the system and “take a look” at how the system is organized. To incorporate this public search feature, one embodiment of the system utilizes both public showrooms and private showrooms for the service providers to advertise their specialties. As their names suggest, a public showroom includes a service provider web page in which the service provider provides more basic information about the services available along with information from the service provider profile. The private showroom includes more specifics, possibly including but not limited to price lists, client lists, photographs, and other personalized information that the service provider makes available only to the most serious prospects for work. Unlike the service provider and consumer profiles on the system, which are intentionally standardized for systematic information gathering, the showrooms allow the service providers to control content and advertise their services uniquely.

Other than providing systematic and consistently objective ways to evaluate their counterparts, service providers and consumers who utilize the system also gain access to management features that are included in the product. In one embodiment, the computer program product that implements the system includes a service management module. This module allows the consumers and service providers to access, among other things, a service contracts database. This database includes contract templates that the consumers and service providers can use to memorialize their agreement in writing. The contractual language is in an editable format so that the service providers and the consumers can adjust the language to suit particular needs without starting from scratch. In this way, the system uniquely provides for service contracts to be established in writing by parties that have not met in person. To implement a written contract, even a contract utilizing electronic signatures only, the computer program includes a fully functional communications module allowing for messaging and information exchange over the internet. By accessing the communications module, the service providers and consumers may exchange text messages and emails, or more substantive documents such as draft or final contracts, invoices, and payments.

The service management module of this invention includes a performance tracker that is applicable to both consumers and service providers. A consumer has the ability to rate the quality of a service provider's work according to a performance scale set forth on the system (e.g., a numeric range from 1 to 10 with 10 being very good and 1 being quite poor). A service provider may rate the consumer in the same way to ensure that other service providers know how that consumer transacts business. In one embodiment, the quality ratings may be divided into different criteria, such as timeliness, price, efficiency, communication skills, prompt payment, and other qualities that individuals to a service contract would find useful for evaluation. Access to this performance information is provided on two different levels. An averaged performance ranking is incorporated into the profiles of both consumers and service providers. A profile, of course, is publicly available. More detailed accounts on the performance tracker are accessible at higher security levels, such as private showrooms, specific performance tracker web pages that require permissions for access, and social networks discussed below.

One other useful feature that may be included in the service management module is that of (i) bundled features management and (ii) tagging tools. The bundled features management program allows the individuals who sign up as system users to select those portions of the system that appeal to them, such as contract management options and contract history options. One useful contract history option allows a service provider to quickly contact all consumers who have used that provider's services. By tagging the consumers who have contracted with that service provider, the service provider can send batch communications (e.g., an email “blast”) to all previous customers on the system via a single message.

The communications module of the computer program associated with this system has been noted above but also includes more extensive functions. First, parties to a proposed service contract can establish the terms of their agreement via this online system. The communications module allows for the exchange of signed writings to memorialize the agreement, and individuals can pay for the transaction via the system as well. In this respect, the service management module described above incorporates an accounting engine that is capable of clearing the exchange of currency in an electronic environment from one account to another. Systems, such as a service provider payment module, utilize credit card payment, debit card transfers from one bank to another and online payment system such as Paypal and Google checkout. These systems are well known and can be implemented herein as a value added online service. Of course, the communications module is capable of using security features to ensure confidentiality of the communications.

One other important use of the communications module is that of establishing a social networking component in the system of this invention. In a social networking environment, consumers and service providers can establish private groups for secure communications. Individuals in these groups have access to confidential messages and other information that is intended only for access by members of the group. This social networking component is useful for service providers to share tips of their trade, client referrals, or other business intelligence. From a consumer perspective, the social networking allows for frank discussion of a service provider's performance, shared experiences in narrative form, and recommendations for members of the group to use certain service providers. In one embodiment, the social networking component may be as simple as a list of service providers that other members of the group have used in the past and how the members felt about the work. The social networking aspect of the system implemented by the computer program product described above is also a useful feature for sharing the detailed performance histories of consumers and service providers as tracked on the system. In a different embodiment, an authenticated member with access to the system may view the detailed performance history of each service provider or consumer who has previously completed contracted work through the website.

With information being quickly and efficiently exchanged between consumers and service providers on the system, one could readily use the communications module of this invention to implement a reverse auction. In the reverse auction scenario, consumers express a need for services within the appropriate service category, and the service providers in that category bid accordingly. The consumer then chooses the best proposal received via the auction.

In yet another embodiment, the invention includes an overall computerized system of connecting service providers and consumers via an online communications network. In this regard, the system coordinates communications between consumers and service providers via a web server operable via the infrastructure of the Internet for coordinating a communications network over the World Wide Web. A plurality of client subsystems operate at points of presence on the World Wide Web and are electronically connected to the web server that utilizes the above described computer program product to establish the system.

In the system embodiment, the web server communicates electronically with client subsystems. The system of this invention may include, but is not limited to, at least one of each of (i) a consumer interface, (ii) a service provider interface, and (iii) an administrator interface. Typically these interfaces are standard computers, but they may include portable telecommunications devices such as cell phones or personal digital assistants. Each of the system interfaces accesses computer controlling commands executable on client and server processors to allow the exchange of data over the system and between any two of the interfaces. Typically, the exchange of data occurs over the website for the online system.

Upon accessing the system from a client interface, the user has access to a service provider catalog on the web server. As noted above, the catalog organizes service provider interfaces according to assigned codes, and a search module on the web server is available for locating service providers in the catalog. The search module is accessible by the service provider, consumer and administrator interfaces for communications there between. The search module has been described above and includes the profiles that are available for searching online, particularly consumer and service provider profiles.

The interfaces at each client subsystem allow individuals to establish appropriate profiles and take proper actions on the system. The consumer and service provider interfaces allow those individuals to establish profiles, access the system features, and communicate across the system, particularly in the social network. The administrator interface has all the rights and privileges that web administrators utilize to manage the overall system-maintaining accounts, deleting accounts, password management, communications oversight, and the like. In one embodiment, the administrator or other individual uses a coding interface to assign categories to services maintained on the platform. The services include events that are publicized on the system.

The service provider catalog is searchable in multiple ways, including code searches, geographic searches including but not limited to zip codes, and name searches.

The system described herein includes other value added features, most likely within the service management module. For example, service providers may place their calendars in their private showrooms so that consumers can schedule work themselves, or at least see available times. This service provider scheduler will immediately let a service provider know whether the service provider is available at the right time or if there is a long wait. Given that the system is set up for electronic payment, the service management module may include accounting reports that allow consumers and service providers to check jobs completed, accounts payable, and accounts receivable.

In yet another embodiment, the computerized method of accommodating communications between consumers and service providers in an online environment includes entering a consistent set of data fields for each service provider in a database stored on a web server, organizing the data sets regarding the service providers on the web server according to codes for the respective service industry, and establishing a search page accessible by consumers from points of presence on the World Wide Web such that consumers enter search commands via a client computer to retrieve the consistent sets of data from the web server regarding the service providers. The method continues with the step of requesting a consistent set of data from consumers accessing the search page and storing the consumer data in a consumer profile. The method of this invention accomplishes its purpose by establishing online communications between a service provider and a consumer.

The method described herein includes the steps of coding the services offered on the service sector platform via a coding interface. The coding may include assigning SIC codes, NAICS codes, IRS codes, zip codes, area codes, or even specially generated custom codes for certain services. These codes enable a user to identify the kind of service of interest among the numerous and diverse kinds of services advertised on the system. The communications aspects of the system bring service providers and consumers together in a single online marketplace.

One particular set of online communications involves negotiating a contract for services. As discussed above, the parties to the transaction may use contract templates available within the system to memorialize their work expectations in writing. This contract document will be available in a format that allows for editing, and then the parties can pass the document back and forth until they reach an agreement. Signed documents may be retained for permanent records either on the system or in an individual's personal files.

In many ways, the online system and computer program product of this invention are sufficiently versatile to allow many known methods of enhancing a user's online experience. For example, many websites benefit from third party advertising in frames around the periphery of the main website. Instant messaging, games, and other computerized enhancements are also within the scope of this invention.

As noted above, one kind of service available for managing via this system is an event (i.e., any activity that is publicized on the system to inform event participants, including potential participants). Accordingly, one embodiment of the system incorporates the computer hardware for connecting and communicating over the internet in a way that allows event organizers (referred to in the Figures as EO) to communicate with event participants (referred to in the Figures as EP). These communications occur via an events manager that has, at least, the following components:
(i) a profile manager for entering and storing identifying information regarding users of the computerized system (e.g., event participants and event organizers);
(ii) a search module for organizing events according to event organizer categories;
(iii) a registration module for extracting profile information from the profile manager and using the profile information from the profile manager in completing a registration for an event advertised on the service sector platform of this invention.

The events subsystem described herein allows a user to create a single profile and use that profile for more than one aspect of daily life or business activities. The same profile information allows one to search and contract for services or to search and register for an event. A single consumer then has more than one option in using the system because the profile information is available for registering for multiple events from multiple event organizers.

The system organizes the events in a way to accomplish easy retrieval of information. The event categories include, but are not limited to, alphabetical lists, a geographical regions list, and a zip code list.

The features described above for the services sector apply in equal force to the events section of this system. After all, an event is a kind of service; an event organizer (EO) is a kind of service provider, and an event participant is a kind of consumer. Accordingly, the all features described above are incorporated by reference to the events section of this system.

The events management components of the system are useful for confidential communications between participants and organizers. The participants are allowed to rate the event, and, vice versa, the event organizers can rate a participant. The events may be public or invitation only, depending on the set-up within the administration of the system.

One aspect of this system is its use of consistent data fields among service providers, event organizers, consumers, and event participants. This consistent set of required data among system users allows a person to make informed choices by comparing like data. Accordingly, in one aspect, the system is a method of facilitating an online review of services and events by comparing data sets defined by the system administrator. The method includes organizing the services and events according to set codes or other organizational factors including geographic location, alphabetical lists, or custom numbering systems created by the administrator and posted on the system.

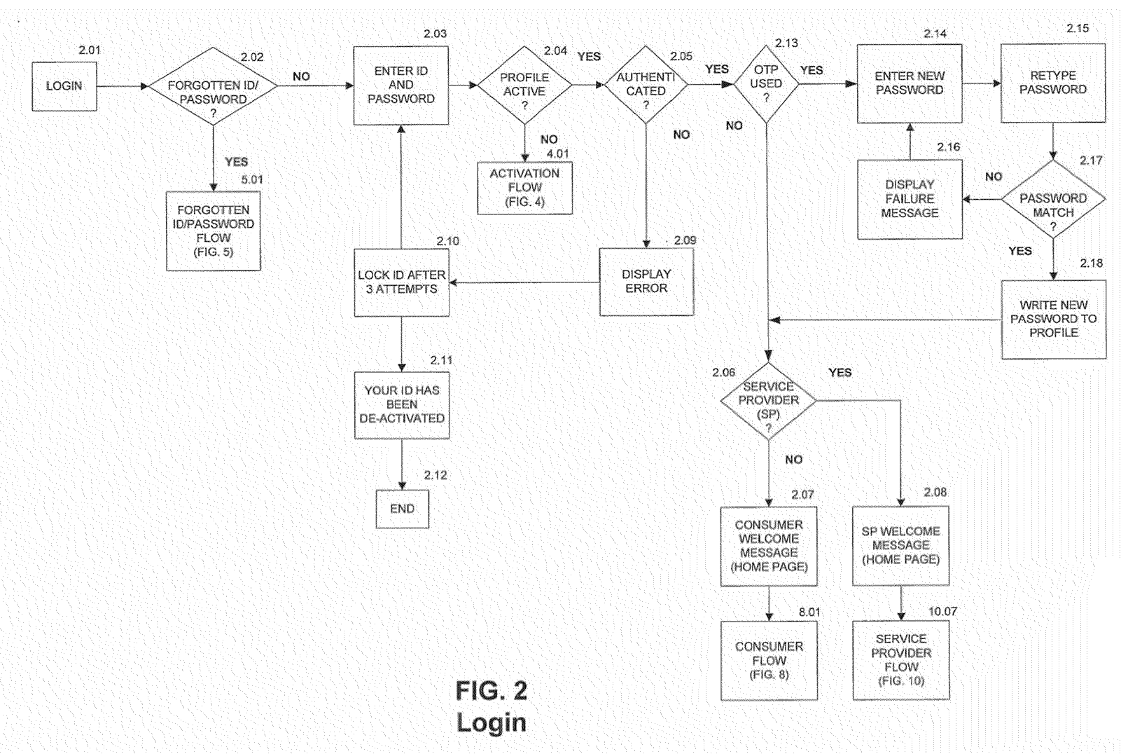

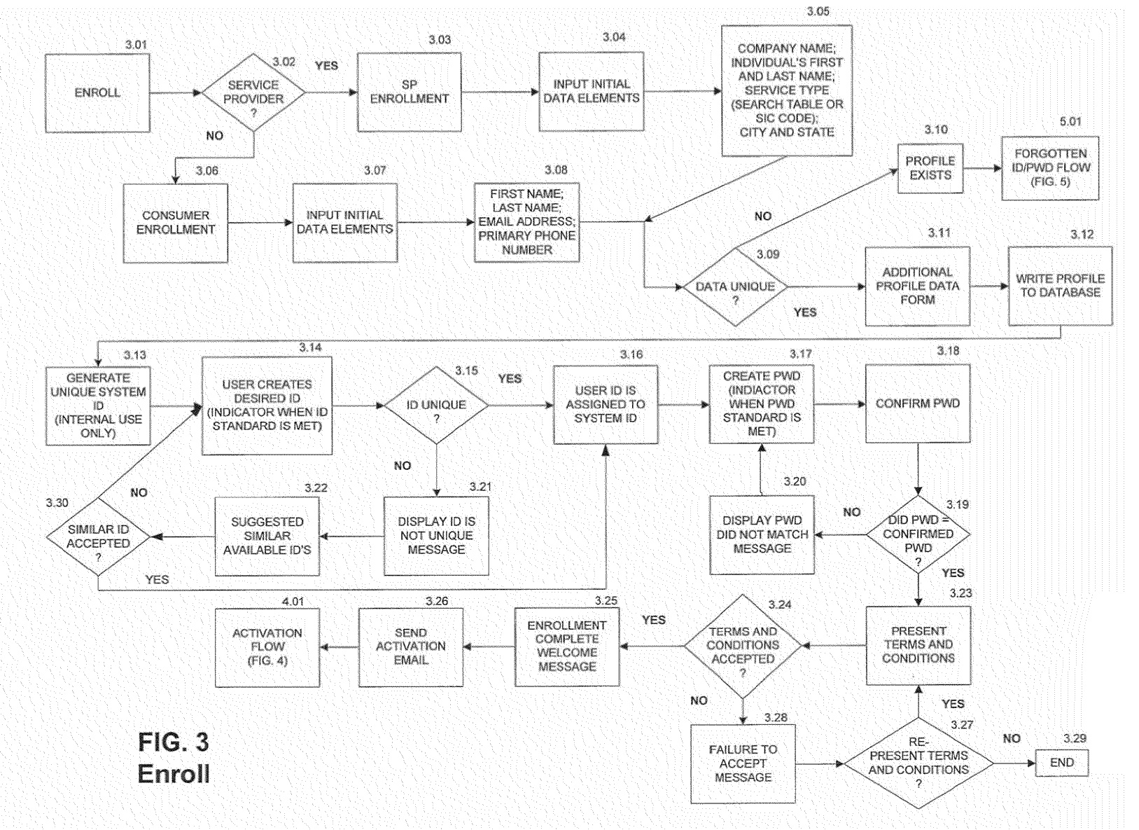

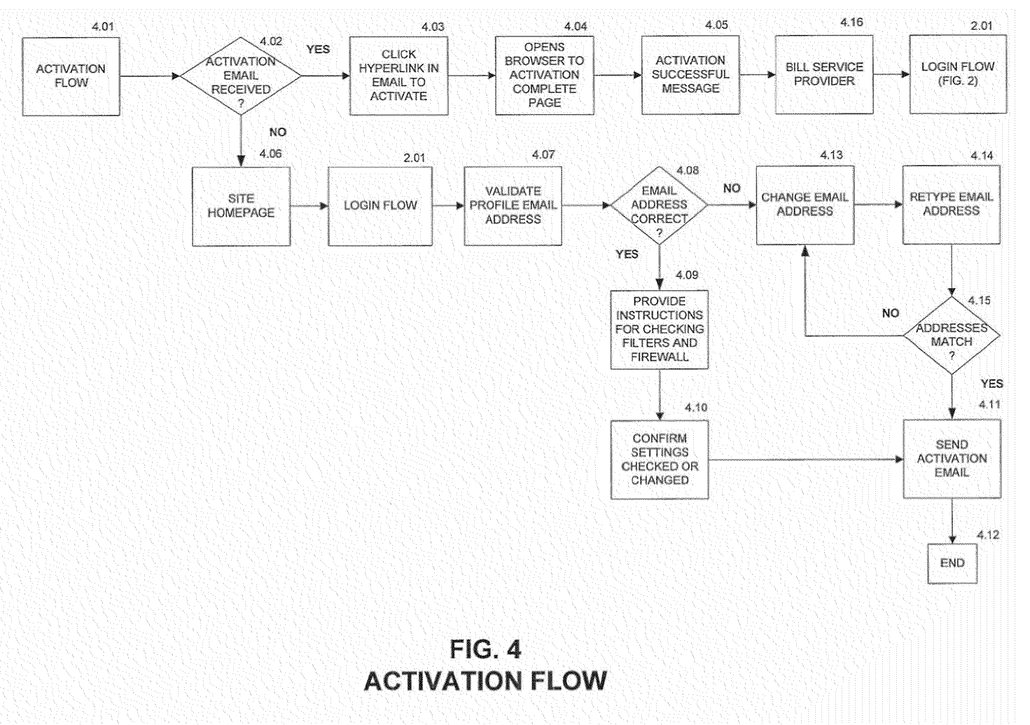

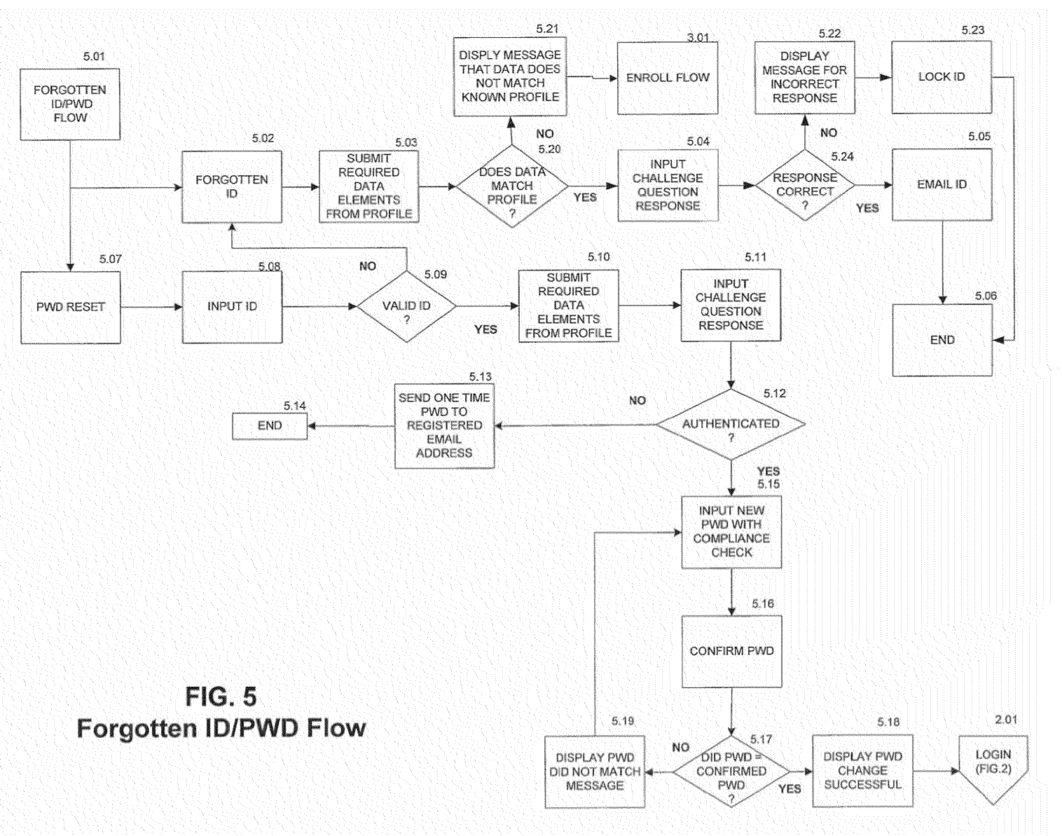

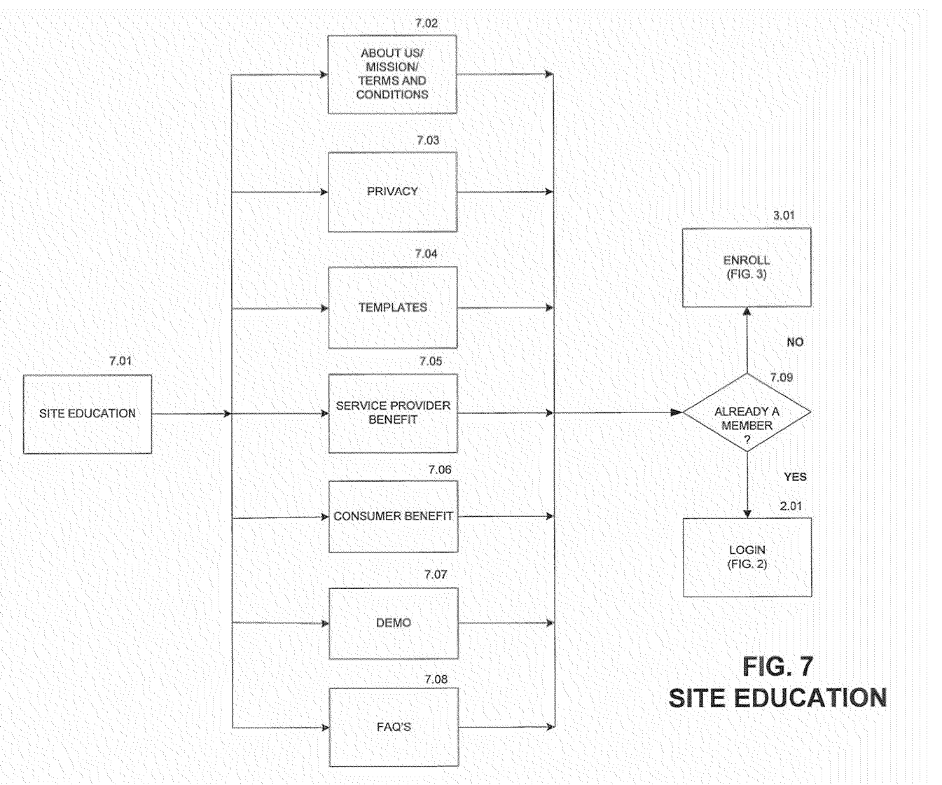

The system described herein is also described in the attached drawings, which show exemplary logic flowcharts for the system. The invention is not limited by these drawings, as other logical methods of programming the system will also work. The drawings are largely self-explanatory and follow the outline of the system described above. As shown in more detail in the Figures, the system encompasses the use of methods for user login and validation (FIGS. 2, 5), enrollment into the system for more in-depth use and features (FIG. 3), account activation (FIG. 4), and a series of instructional screens to teach a user how to work efficiently within the system (FIG. 7).

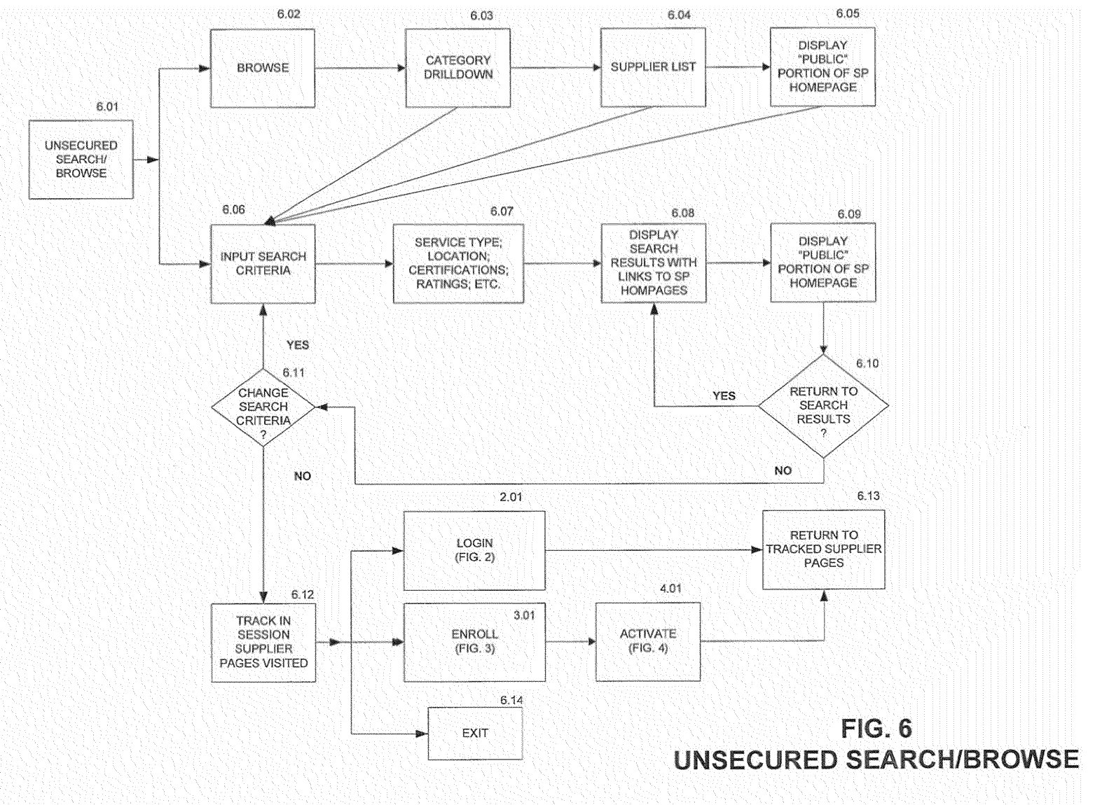

The public search functions are set forth in FIG. 6 and may include the codified services and/or the organized events that are available for searching.

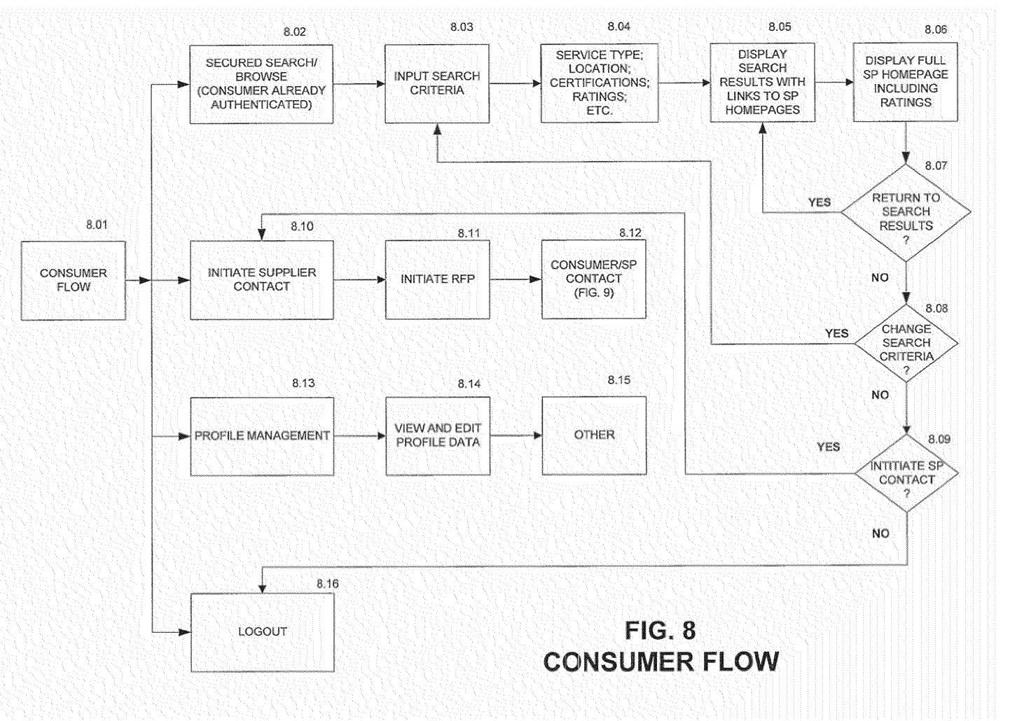

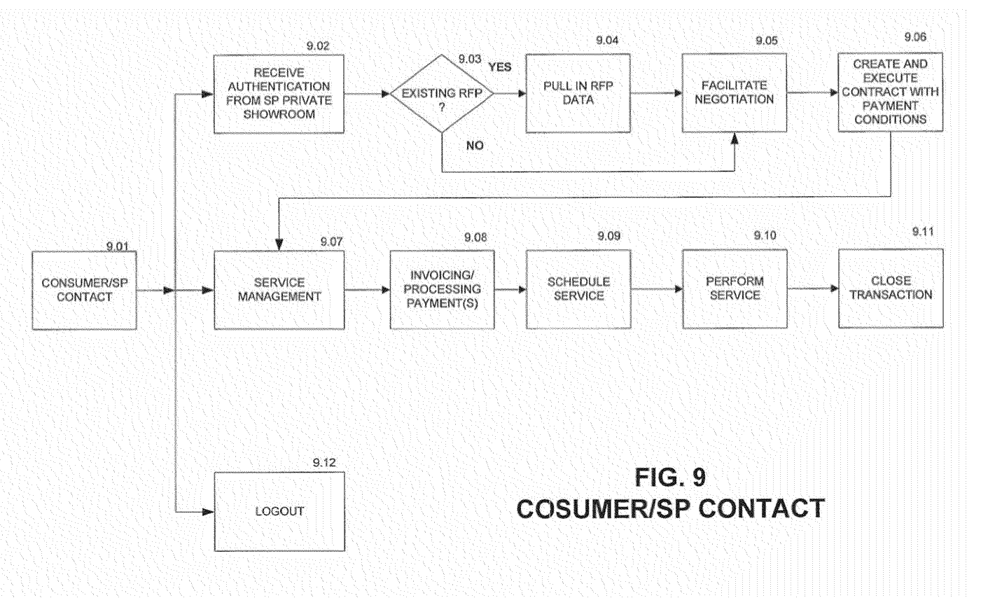

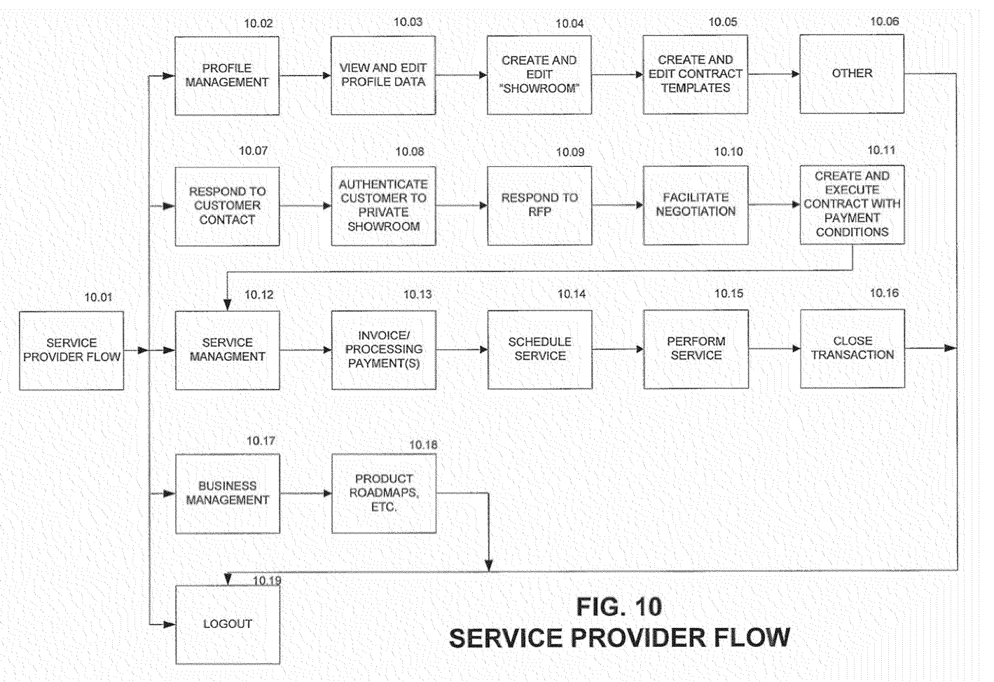

FIGS. 8-10 show a suggested, but not mandatory, logical routing of information by which consumers search, locate, assess, and select a service provider (FIG. 8). FIG. 9 includes negotiation features by which a consumer engages a service provider, and FIG. 10 sets forth a corresponding flowchart with features useful to the service provider in communicating with the consumers.

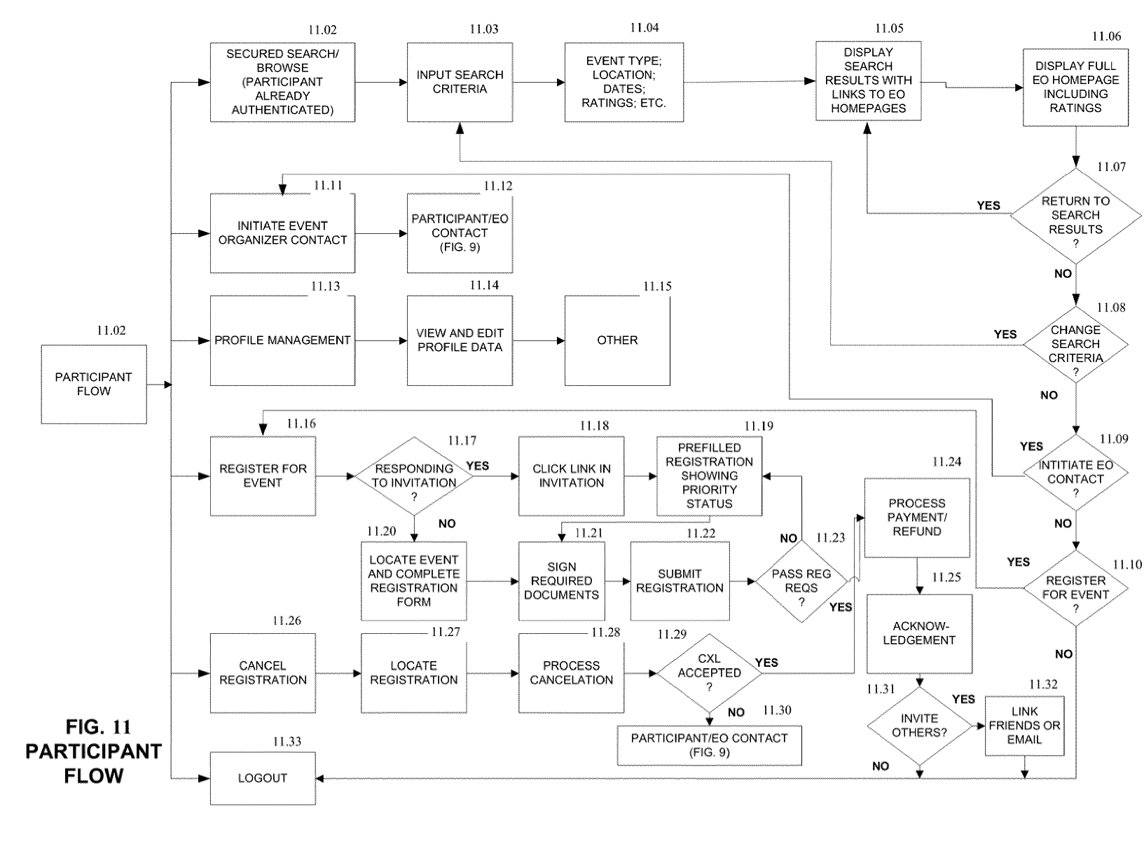

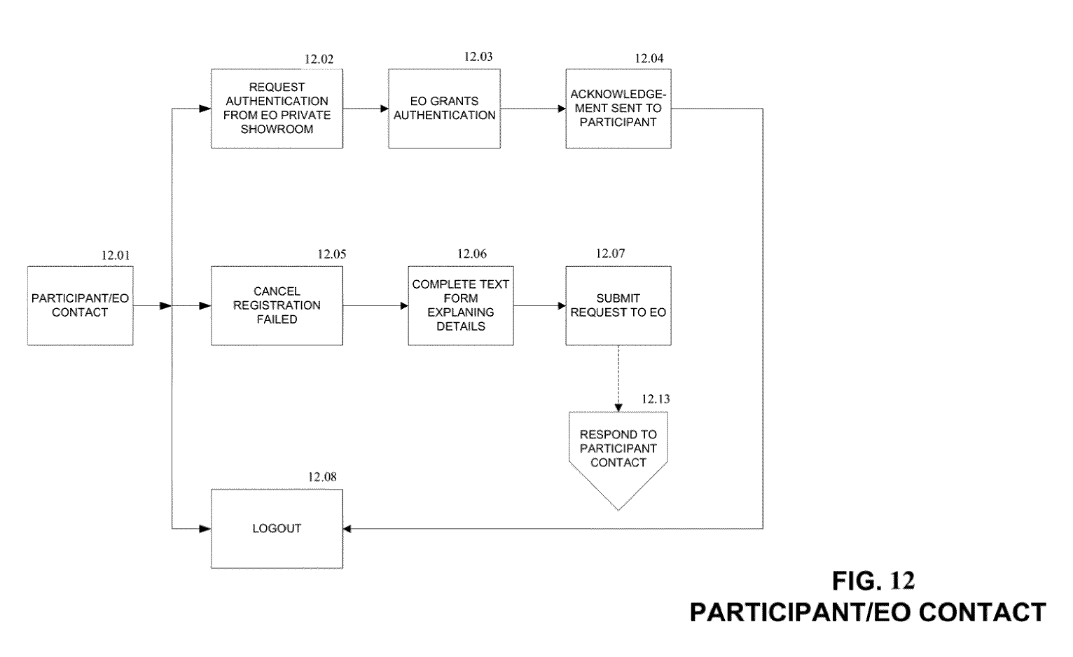

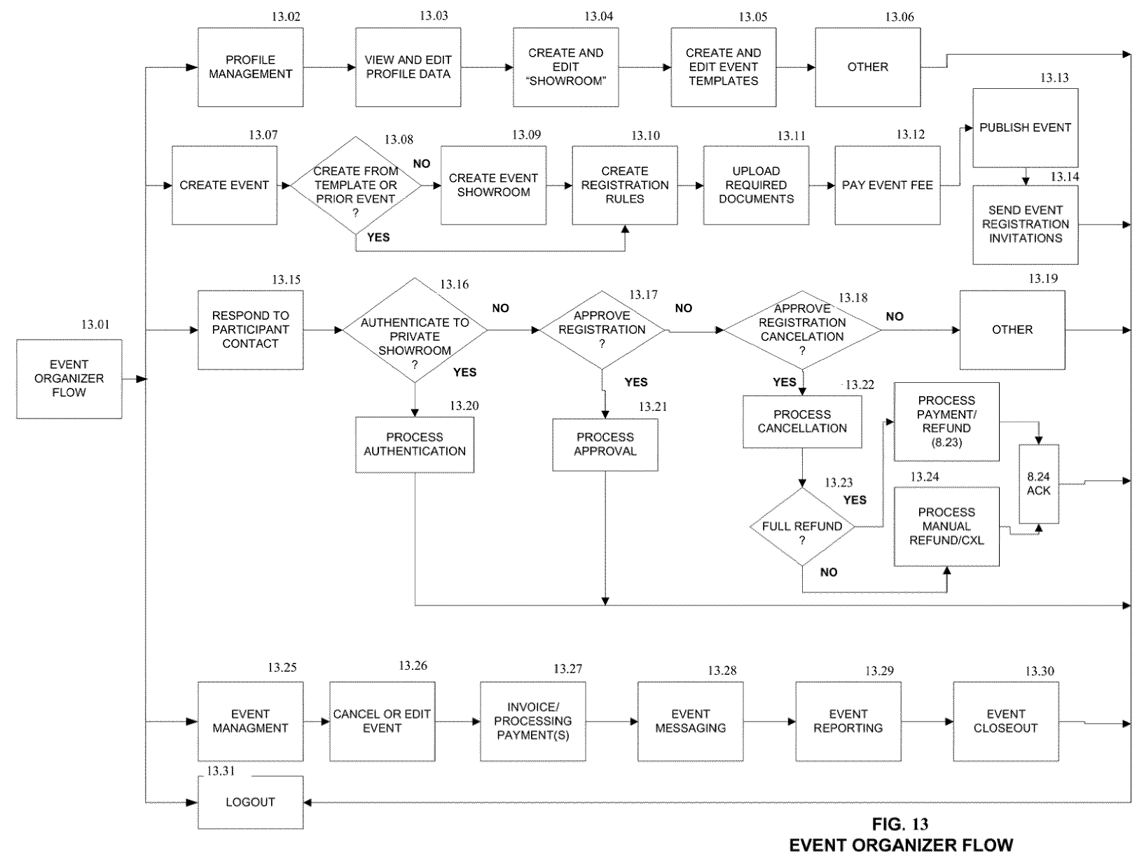

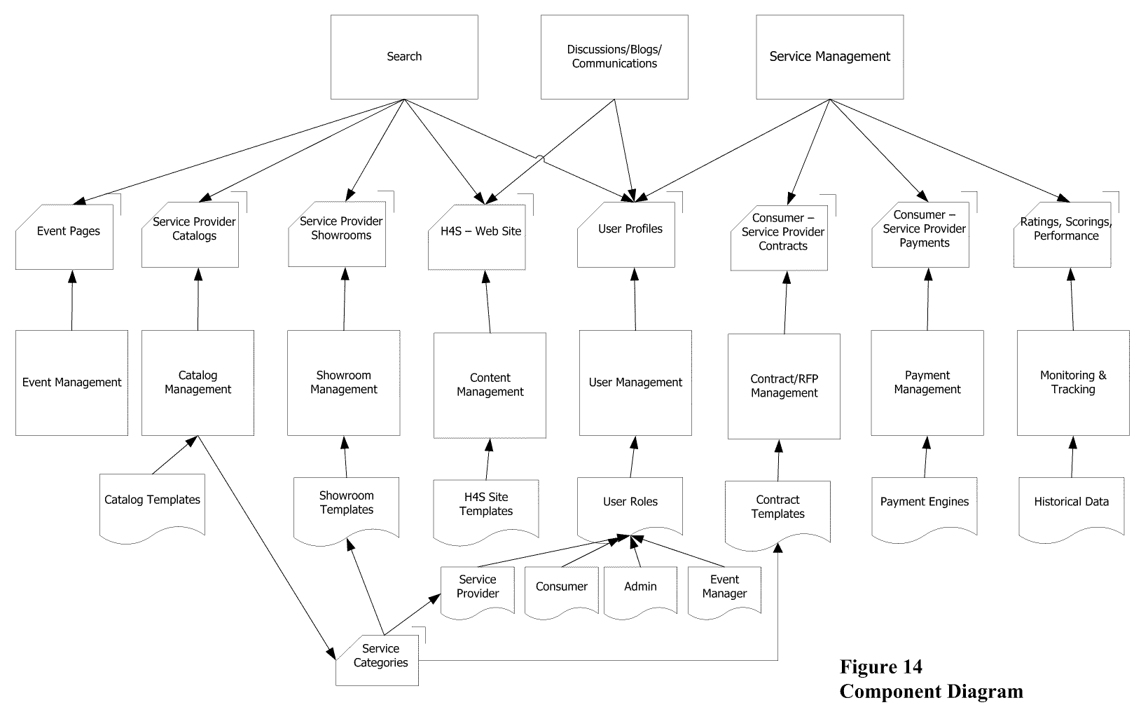

FIGS. 11-13 are corresponding sections of the system directed to event management. A high level overview of the architecture is shown in FIG. 14.

In the specification and drawings, typical embodiments of the invention have been disclosed and, although specific terms have been employed, they have been used in a generic and descriptive sense only and not for purposes of limitation. Different kinds of computer hardware and system components may be substituted for the parts disclosed herein and still fall within the ambit of the invention.

These and other attributes of the system are set forth in the following claims.

1. A computerized system of connecting service providers and consumers via an online communications network, the system comprising:
a web server operably connected to the infrastructure of the internet for coordinating the communications network over the World Wide Web;
a plurality of client subsystems operated at points of presence on the World Wide Web and electronically connected to said web server, said client subsystems comprising at least one of each of a consumer interface, a service provider interface, and an administrator interface, wherein said interfaces comprise computer controlling commands executable on client and server processors to allow the exchange of data between any two of said interfaces;
a coding interface for categorizing service provider interfaces according to assigned codes;
a service provider catalog on said web server, said catalog organizing service provider interfaces according to the assigned codes;
a search module on said web server for locating service providers in said catalog, said search module being accessible by said service provider, consumer and administrator interfaces for communications there between.

2. A computerized system according to claim 1, wherein said assigned codes are SIC codes.

3. A computerized system according to claim 1, wherein said assigned codes are NAICS codes.

4. A computerized system according to claim 1, wherein said search module comprises service provider profiles.

5. A computerized system according to claim 4, wherein said service provider profiles include standardized data fields.

6. A computerized system according to claim 5, wherein said standardized data fields are selected from the group consisting of name, address, years in business, geographical areas served, identified areas of expertise, professional accrediting, and number of customers served.

7. A computerized system according to claim 1, wherein said service provider interface comprises a service provider showroom.

8. A computerized system according to claim 7, wherein each of said service provider showrooms are divided into a respective public showroom and private showroom.

9. A computerized system according to claim 8, wherein each of said public and private service provider showrooms comprises at least one webpage.

10. A computerized system according to claim 1, wherein said consumer interface comprises a web page allowing data entry to establish a consumer profile on said web server.

11. A computerized system according to claim 1, wherein said administrator interface comprises a service management module for managing communications among a consumer, a service provider, and a site administrator operating said web server.

12. A computerized system according to claim 11, wherein said service management module comprises a service contracts database.

13. A computerized system according to claim 11, wherein said service management module comprises a service provider payment sub-system.

14. A computerized system according to claim 11, wherein said service management module comprises a performance tracker.

15. A computerized system according to claim 11, wherein said performance tracker comprises a historical database of consumer transactions and service provider transactions.

16. A computerized system according to claim 15, wherein said historical database is accessible via said consumer interface and said service provider interface.

17. A computerized system according to claim 11, wherein said service management module comprises a tagging tool for tracking consumers that have contracted with respective service suppliers.

18. A computerized system according to claim 17 wherein said tagging tool provides a means for service providers communicating with previous clients on the system.

19. A computerized system according to claim 11, wherein said service management module comprises a service provider scheduler.

20. A computerized system according to claim 11, wherein said service management module comprises an accounting reporting function.

21. A computerized system according to claim 11, wherein said service management module comprises a social networking subsystem for accommodating secured communications between identified members of a group of individuals.

22. A computerized system according to claim 21, wherein said secured communications comprise a webpage showing a member's history of transactions, ratings and comments regarding the transactions.

23. A computerized system for establishing an online advertising and communication system used by event organizers for managing event participants' information, the system comprising:
a computer readable storage medium comprising commands stored thereon for connecting a plurality of computers on the World Wide Web, the commands comprising:
a communications module executable by a computer processor to allow communications between the event organizers and the event participants; and
an events manager comprising:
a profile manager for entering and storing identifying information regarding users of the computerized system;
a search module for organizing events according to event organizer categories;
a registration module for extracting profile information from the profile manager and using the profile information in completing a registration for at least one event,
wherein the same profile information is available for registering for multiple events from multiple event organizers listed in the search module.

24. A computerized system according to claim 23, wherein said event organizer categories comprises an alphabetical names list.

25. A computerized system according to claim 23, wherein said search module conducts a public search.

26. A computerized system according to claim 23, wherein said search module conducts a secured search.

27. A computerized system according to claim 23, wherein said events manager implements an event organizer's review of an event participant identified within said profile manager.

28. A computerized system according to claim 23, wherein said events manager implements a payment module.

29. A computerized system according to claim 23, wherein said events manager implements invitation-only event registration.

30. A computerized system of connecting service providers and consumers via an online communications network, the system comprising:
a web server operably connected to the infrastructure of the internet for coordinating the communications network over the World Wide Web;
a plurality of client subsystems operated at points of presence on the World Wide Web and electronically connected to said web server, said client subsystems comprising at least one of each of a consumer profile manager and a service provider manager, wherein said managers comprise computer controlling commands executable on client and server processors to allow the exchange of data between said managers;
a coding interface for categorizing service providers according to assigned codes;
a service provider catalog on said web server, said catalog organizing service provider interfaces according to the assigned codes;
wherein said managers communicate to transmit data from a consumer profile to multiple service providers comprising at least one event organizer.

31. A computerized system according to claim 31, wherein said assigned codes are zip codes related to the event.

32. A computerized system according to claim 31, wherein said catalog comprises service provider profiles.

33. A computerized system according to claim 34, wherein said service provider profiles include standardized data fields.
